(19) United States
(12) Patent Application Publication
(10) Pub. No.: US 2008/0073354 A1
(43) Pub. Date: Mar. 27, 2008

(54) Beverage Mug

(76) Inventor: MAGAS JAROSLAV OLEGOVICH, Kharkiv (UA)

Correspondence Address: HOUSTON ELISEEVA, 4 MILITIA DRIVE, SUITE 4, LEXINGTON, MA, 02421, US

(21) Appl. No.: 11/949,335

(22) Filed: Dec. 3, 2007

Related U.S. Application Data
(63) Continuation of application No. PCT/UA2006/000010, filed on Mar. 6, 2006.

(30) Foreign Application Priority Data
Jun. 3, 2005 (UA) U200505282

(51) Int. Cl. F17C 13/00; A47G 19/22; B65D 1/34

(52) U.S. Cl. 220/560.03; 220/571; 220/719

(57) ABSTRACT

The invention is a beverage mug with a storage chamber for spillage. Its scope of use is public catering, including transport catering, pottery for general use. The beverage mug comprises the walls, a bottom, and a handle wherein there is a storage chamber for collecting the spillage, a chute on the outer surface for diverting the spillage to the storage chamber. The present invention is a beverage mug with a lower probability of spillage and staining of the surrounding objects resulting from abrupt and incautious movements and pounding with no need of a saucer.

### RELATED APPLICATIONS

This application is a continuation application of International Application PCT/UA2006/000010 filed on Mar. 6, 2006, which, in turn, claims priority to Ukrainian Patent Application No. u200505282 filed on Jun. 3, 2005, which is incorporated herein by reference in its entirety.

### BACKGROUND OF THE INVENTION

The instant invention relates to pottery and can be used in public catering, and more specifically in transport catering.

Cups and mugs provided in the known art consist of the walls hermetically integral with the bottom and a handle on the outer surface of the walls (as in a promotional leaflet of bouillon cubes “Maggi” Hot Cup 2004). The shortcoming of the known cups is that when handled without caution, they stain the table or surrounding objects. When the beverage is poured or stirred with the spoon, when sugar is added or the mug is shaken, the beverage spills out, flows down the outer walls and stains the surrounding objects. In order to prevent staining, cups are used together with saucers collecting the liquid. However, when the cup is lifted from the saucer, a small amount of beverage remains on the bottom of the cup. This beverage can make a drop and stain the surrounding objects, e.g. clothes. In order to prevent this, the saucer, as a rule, is held under the cup. This procedure requires the use of both arms and caution. In the business setting beverages are consumed during phone conversations and work on a computer, thus making using the saucer inconvenient (because both arms must be free).

The known art includes a cup with attachment for catching the drip (U.S. Pat. No. 3,279,638). This attachment is made in such a way that the beverage overflowing the rim is directed into it and stays there no matter how the cup is tilted. The shortcoming of the given construction is that this attachment has a very complex form, making the after-use washing impossible (it is very difficult to wash the attachment with water and clean the residue, while after washing it is impossible to pour out a large amount of liquid that stays in the attachment with drink residue). Another imperfection of this solution is its bigger size and weight of the beverage cup, which negatively affects ease of use and esthetics of the cup.

The closest analog is a drip catch mug with a chute and storage chamber (U.S. Pat. No. 5,975,333). In accordance with that patent, the spillage gets into the chute with one upper and one lower point and inclinations between them. The lower point is connected with the storage chamber, so that the drip caught by the chute is diverted to this storage chamber. The storage chamber is triangularly shaped, making the liquid stay inside when the mug is tipped over. One of the shortcomings of this mug is a small tilt angle of the chute not providing for safe direction of liquid to the storage chamber when the position of the mug is not vertical. Owning to the small tilt angle, the speed of liquid flow down the chute is low, which increases the probability of the splashing and staining the surrounding objects when the mug is tilted during drinking. The size of the storage chamber is too small, and only a small amount of liquid can be collected (low capacity). The storage chamber is attached to the rear of the mug, therefore, if the added container is made larger, the mug will increase in size horizontally, occupy more place on the table, and acquire the unusual ellipsoid shape. Washing the storage chamber is rather difficult and is only possible when the drainer is open. Drain and special mug require additional manipulations, which is uncomfortable and impractical. During use, the mug can depressurize, and that loss of pressure will make further use of the mug impossible. Its shape and lateral location of the storage chamber complicate the manufacturing process, because principally new techniques and equipment are needed. Additional elements (hermetic cap) increase the cost of the product.

### SUMMARY OF THE INVENTION

It is an object of the present invention to modernize the mug with a chute and a storage chamber/attachment by modification of the shape of the elements and their location, increasing the speed of the liquid flow in the chute, making washing of the attachment easier, avoiding additional parts and manipulations, and achieving maximum compactness without downsizing the attachment, thus, increasing the efficiency of the mug, improving its ergonomic properties, comfort and practicability, and simplifying the manufacturing process.

To accomplish the above-referenced object, this invention is embodied in the form of a mug comprising a handle, a main container for beverages, storage chamber for collecting the spillage, and a chute on the outer wall for diverting the spillage to the storage chamber. According to this invention, the chute has two upper and two lower points for directing the spillage to the storage chamber—a drip catch storage chamber located under the main container and having two drain holes connected with lower points of the chute.

This chute, with two upper and two lower points, has bigger tilt angles providing for higher speed of the liquid flow to the storage chamber. For that reason, the spillage does not stay in the catch flow and cannot splash on the surrounding objects when the mug is tilted during drinking. The higher speed of the liquid flow provides for the smaller depth and width of the chute. The location of the storage chamber under the main container provides for the improved compactness of the beverage mug—one body consisting of two chambers, preservation of the usual look and esthetics of the mug, variation of the size of the storage chamber without changing the mug's horizontal dimensions (body diameter). The body of the mug can be cylindrical, enabling manufacturing with moulds and standard equipment. Availability of two opposite drain holes eases washing of the added container with water.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a general view—rear elevational view, longitudinal view.

FIG. 2 is a general view—front view.

FIG. 3 is a schematic view of an embodiment of the invention with spherical bottom of the main container and tilted drain holes.

FIG. 4 is a schematic view of the bottom of the storage chamber.

FIG. 5 is a schematic view of an embodiment of the invention with a chute with one upper and one lower point and one drain hole in the storage chamber.

FIG. 6 is a schematic view of an embodiment of the invention with a chute with two upper and two lower points and one drain hole in the storage chamber.

FIG. 7 is a schematic view of an embodiment of the invention with a chute and a container.

FIG. 8 is a schematic view of an embodiment of the invention with removable attachment.

FIG. 9 is a schematic view of an embodiment of the invention with a chute and a container/attachment—rear elevational view and longitudinal view.

FIG. 10 is a schematic view of an attachment as a separate element.

FIG. 11 is a schematic view of an attachment together with the handle as a separate element.

FIGS. 12-17 are schematic views of the chute and designs of the drain holes.

FIGS. 18-21 are schematic views of the chute profiles—longitudinal view.

FIG. 22 is a schematic view of the shapes of the outer walls.

FIG. 23 is a schematic view of the matrix—top view, longitudinal view.

FIG. 24 is a schematic view of the matrix, forming method—longitudinal view.

FIG. 25 is a schematic view of the combinations of the shapes of the inner and outer walls—top view, longitudinal view.

FIG. 26 is a schematic view of an embodiment of the invention with the water absorbing chamber.

FIG. 27 is a schematic view of an embodiment of the invention with the water absorbing chamber and adhesive material.

### DETAILED DESCRIPTION OF THE PREFERRED EMBODIMENTS

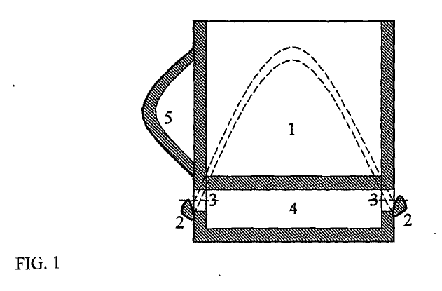

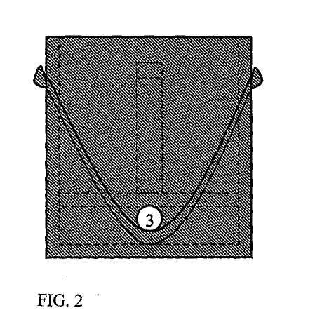

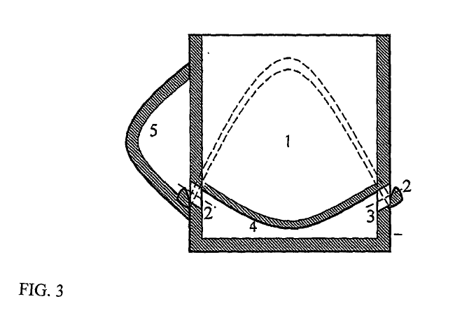

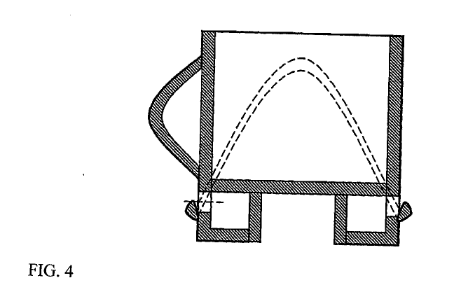

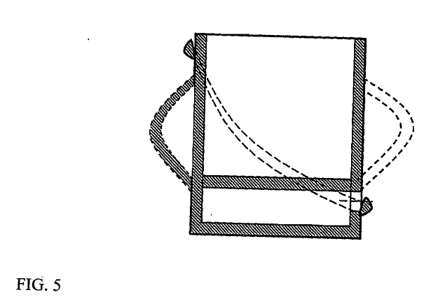

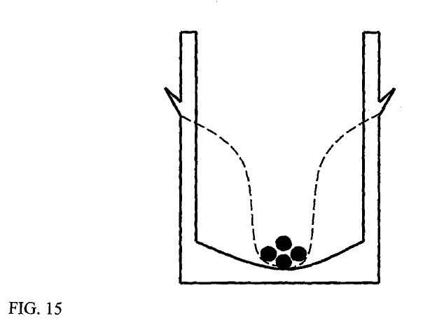

According to the invention (FIG. 1, FIG. 2), a beverage mug with a handle is supplemented by a drip catch storage 4 chamber located below a main 1 container and made as a double bottom. The bottom of the main container can be both flat and spherical (FIG. 3). A spherical bottom provides for an increased diameter of the drain holes and placing them higher without increasing the area of the storage chamber, thus without decreasing the volume of the main container. At its rear, the storage 4 chamber has either one or two diametrically opposed drain holes 3 (FIG. 1, FIG. 2). In order to keep the storage chamber free of insects, the drain hole (holes) can be supplemented by metal or polymeric nets. The invention contemplates an embodiment where the drain hole (holes) are substituted by the cluster (clusters) of drain holes (FIG. 15) consisting of the minimum two-six smaller drain holes. In the embodiment with two diametrically opposed holes, a handle is located above one of the drain holes. In the design with one drain hole (FIG. 5), a handle can be located both above the drain hole or on the diametrically opposed side. The lower part of the handle 5 attached to the beverage mug wall (lower base) can be located both above (FIG. 1) or below (FIG. 3) the drain hole of the storage chamber. The embodiment in which the lower handle base is located below the drain hole permits to increase the size of the handle, which would be feasible, for instance, in beer mugs.

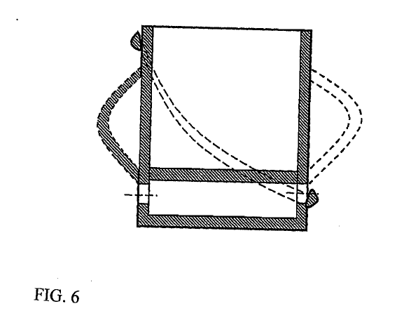

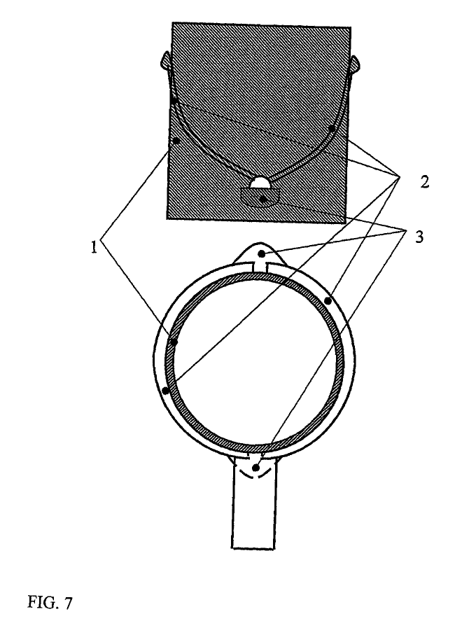

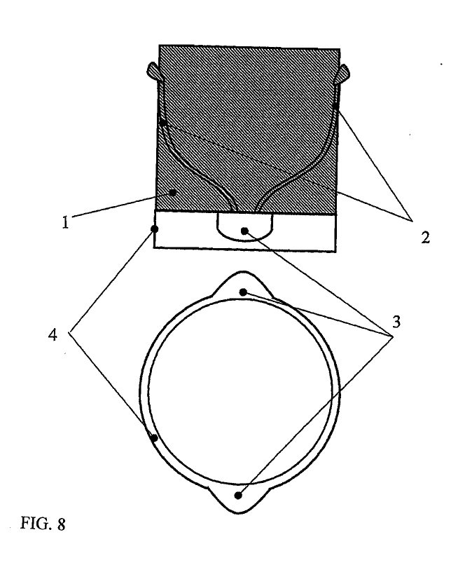

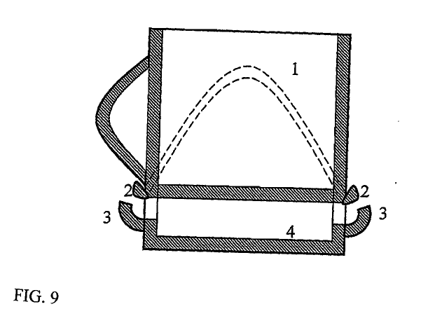

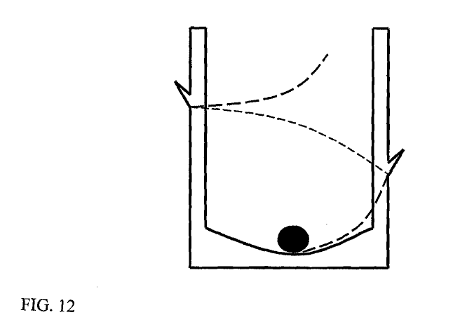

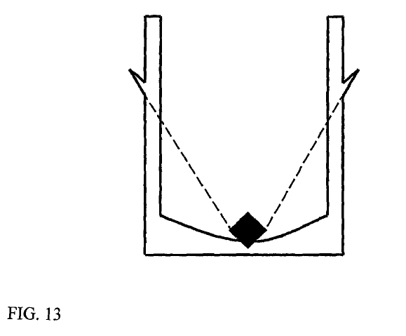

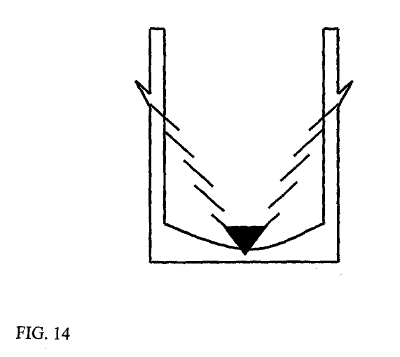

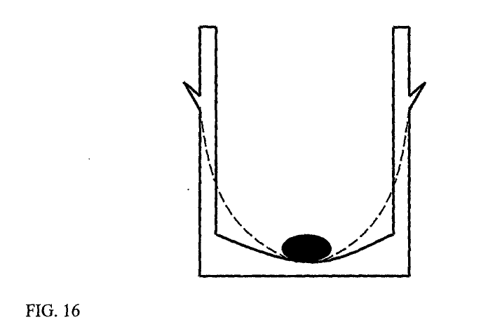

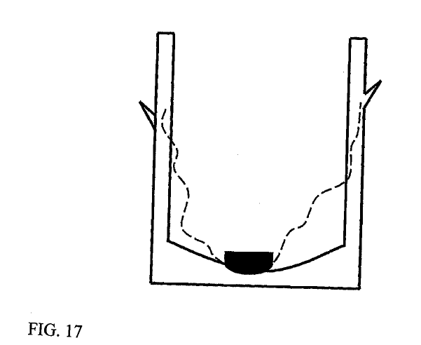

The walls of the beverage mug comprise a chute 2 (FIG. 1, FIG. 2) for capturing and diverting the spillage to the drain hole (holes) 3. In the embodiment with one drain hole (FIG. 5), the chute has one lower point connected with the drain hole, and one upper point. In the design with two drain holes (FIG. 1, FIG. 2), the chute has two lower points connected to the drain holes, and two upper points. The invention contemplates an embodiment with two drain holes and a chute with one lower and one upper point (FIG. 6). A chute 2 with two upper and two lower points can be designed like a closed (the beginning and end are connected) double wave (sinusoid), this embodiment being the optimal, because it enables maximally efficient capturing of the drip. Upper points of the chute can be located at different levels for implementing the designer's idea (FIG. 17). The chute can be zigzag-shaped with pointed ends (upper and/or lower points) (FIG. 13), while the drain holes of the storage chamber can be triangular, rhomboid, square, rectangular (FIGS. 13-14) in shape. If the chute's ends are rounded, the drain holes can be round, oval, or semicircular (FIGS. 12, 16-17) in shape. The drain holes (hole) of the storage chamber (in the rear wall) can be made at the right angle (FIG. 1) or with a tilt (FIG. 3). The shape of the chute can vary: it can be straight, wavy, arch bent to different sides, upwards or downwards (FIGS. 13, 15-17). The chute can be spiral (FIG. 12). There can be a separate chute for each drain hole, spiral or of other shape allowing for the flow of liquid. Such chutes can intersect crossways or run parallel. The chute can be made of separate portions, like cascading steps, tilted and allowing for gradual flow of the liquid to the drain hole (holes), like the tiled roof (FIG. 14). The chute 2 can consist of two parts (FIGS. 7, 8) and have its ends connected to the drain hole with a container 3 (FIGS. 7-9). In the embodiment with the detachable storage 4 (FIG. 8), the drain hole can be formed by the container 3 itself (FIGS. 8, 9).

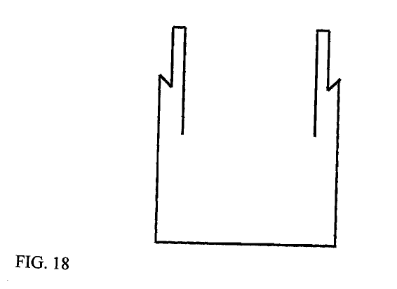

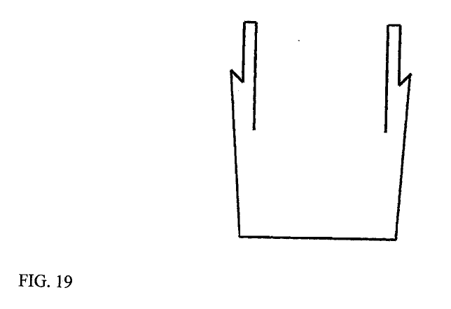

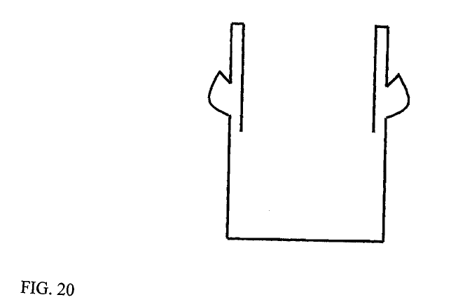

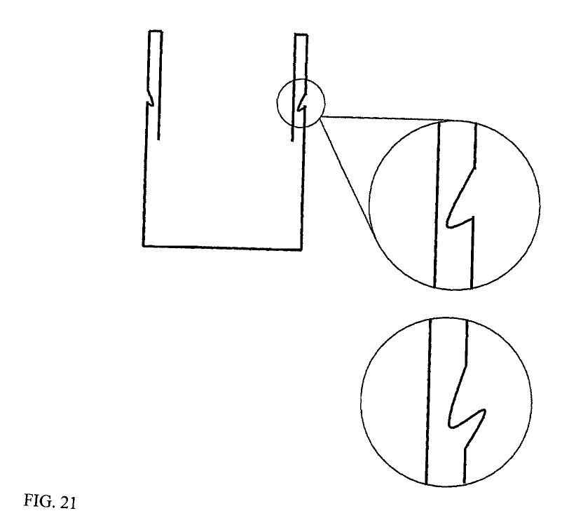

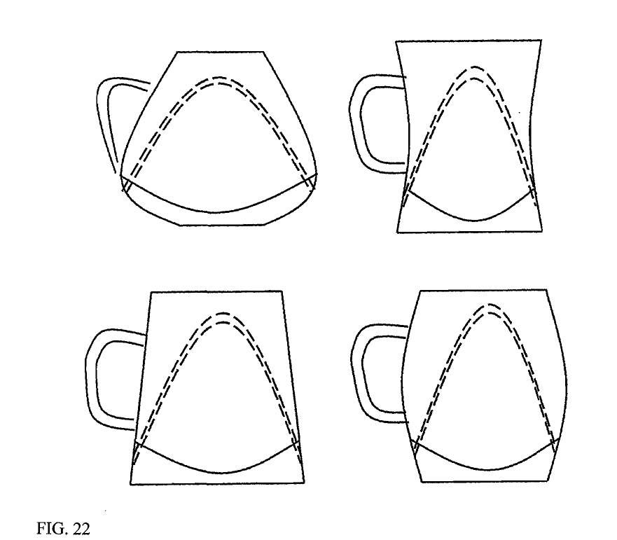

The profile of the chute can vary, for example, and be flat with a sharp petal-shaped edge (FIGS. 12-17), or thick with rounded edge (FIG. 20). The chute of a rounded profile is better protected from chipping and usage-related damages. The chute can also be formed by the difference in the diameters/sizes of the upper (above the chute) and lower (below the chute) parts of the beverage mug (FIGS. 18-19). The chute can be deepened into the wall, fully or partially (FIG. 21). The walls of the beverage mug can be vertical or tilted, which provides for an increase or decrease of the size of the main opening in relation to the bottom (narrowing or widening of the beverage mug upwards), they can also be straight or freely bent, for example, narrowing (beverage mug with a waist) or widening (barrel-shaped) in the middle part of the beverage mug (FIG. 22). The walls narrowing the size of the main opening in relation to the bottom (narrow upwards) are the most effective in terms of the drip collection.

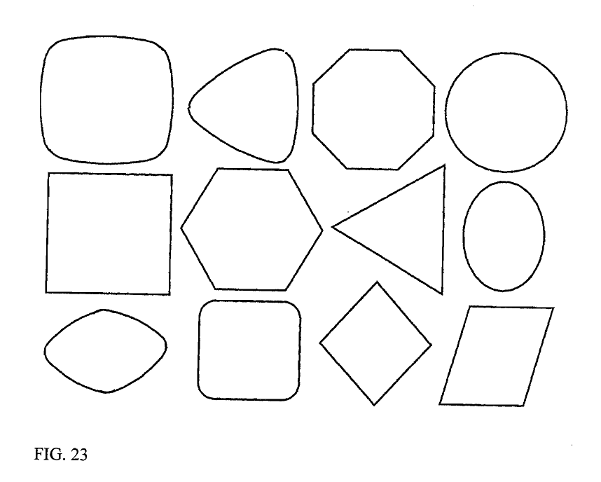

In the cross-sectional (top view), the body of the beverage mug can be circular, square, rectangular, rhomboid, oval, triangular, polygonal (five, six, or more angles), or of other shape (FIG. 23). It can be rectangular, while upper and lower points of the chute, drain holes of the storage chamber coincide with angles of the main container.

The beverage mug can be comprised of three elements: 1—a body comprising the walls, the chute and the bottom of the main container; 2—handle; 3—bottom of the additional space (added container). Then the elements are brought together and fixed. Manufacturing of the body with the walls, chute, and bottom of the main container together with a handle is also possible.

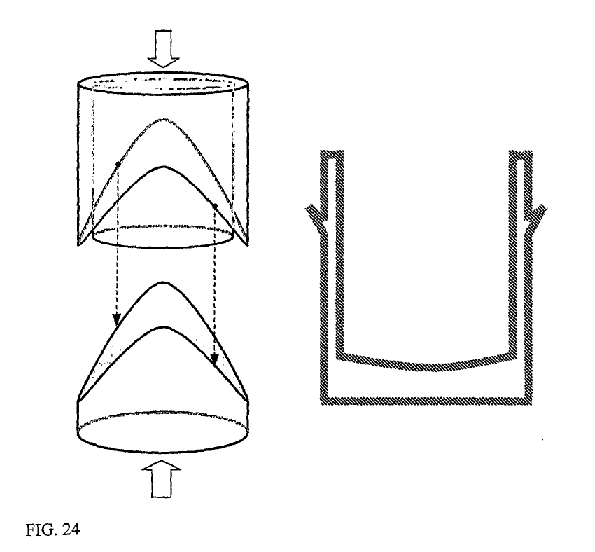

FIG. 24 presents the matrix (parts of the matrix are connected along the chute line), and the longitudinal section of the body of the beverage mug made by integral casting. Inner and outer walls of the beverage mug are divided. The main container is formed by the internal bottom together with the internal walls becoming, along the upper rim of the beverage mug, the outer (external) lateral walls with the chute, handle, and outer/external bottom. The storage chamber is formed by the space between the inner and outer bottom, inner and outer rear walls. The distance between the inner and outer rear walls can disappear in the process of casting due to the increased thickness of the material and fusion of the inner and outer rear walls, which provides for higher durability of the beverage mug. It is possible to cast the beverage mug in a different way, so that the handle makes a separate element that is later attached and fixed.

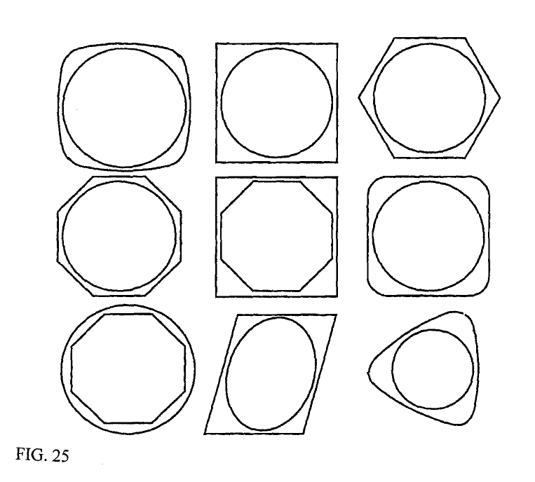

It is possible to make a ceramic beverage mug by making the body without the chutes, which are made or cast separately and then attached to the walls. The form of the inner and outer walls can vary (FIG. 25): for example, the form of the inner walls—round, the outer walls—square, triangular, polygonal; the form of the inner walls—oval, the outer walls—rectangular, triangular, rhomboid, polygonal. Besides, in places where the distance between the inner and outer walls is minimal, the walls can fuse by forming fixity lines.

Additional storage 4 can be detachable (FIGS. 8, 9) and threadedly attached to the body 1, or with a help of a magnet, a suction cup, the slots forming the lock when rotated (with “open”-“locked” positions) etc. In the lower point, near the drain hole 3 of the storage 4 (FIGS. 8, 9) the chutes are distanced from each other, and the liquid flows to the container through this slot that. Air tightness at the junction point can be ensured by a liner made of rubber or other elastic material.

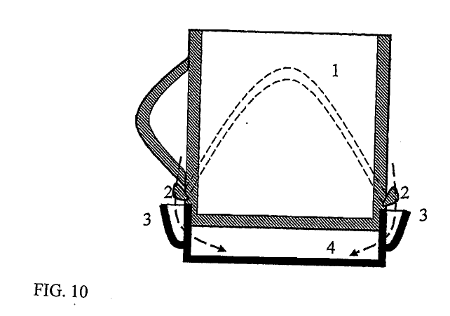

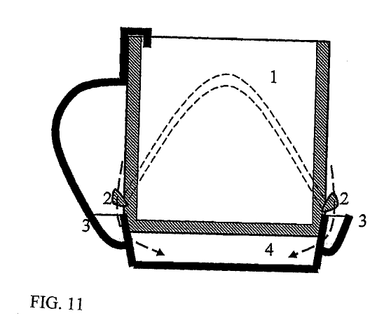

Additional storage can be a separate element attached to the body by using an adhesive material, such as glue ensuring a safe and airtight junction. Besides, the additional storage can be permanently attached to the main container during manufacturing. (FIGS. 10-11).

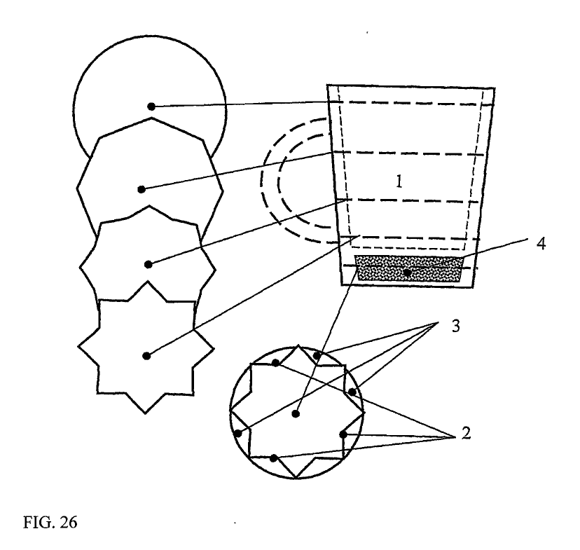

The storage container might require special exchangeable cartridges (as plate 4 in FIG. 26) absorbing liquids similar to the functionality of diapers, or tampons or pads. The cartridges can be filled with chemical filler turning a liquid into a gel. The cartridges are to be changed periodically. The beverage mug with the additional space requiring plates can have more drain holes 3 (FIG. 26) for example, 3-8 and more located around (along the perimeter) the beverage mug. The handle can be located anywhere or be absent (the beverage mug can be shaped like a glass or a goblet). Each drain hole can be connected with a chute 2 (FIG. 26) collecting liquid in its sector only. The chutes can be formed by the spaces between the comers of the polygonal beverage mug. FIG. 26 presents the chute formed by a gradual change of the profile.

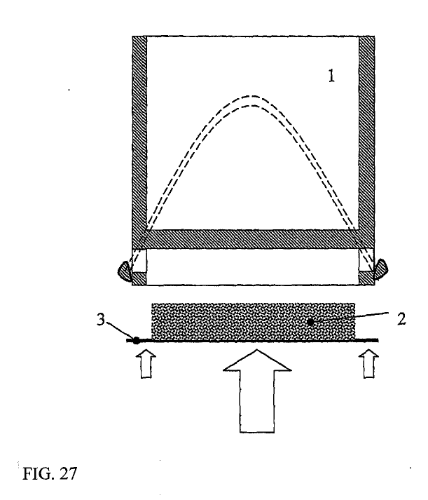

It is also possible to make the storage chamber without the bottom (FIG. 27). In this case, the cartridge-plate absorbing the liquid 2 does have a bottom 3 hermetically attached to the body 1 of the beverage mug, for example, by an adhesive tape (FIG. 27). When the plate is changed, the tape is unstuck and the plate removed.

The beverage mug with an additional storage (4 in FIGS. 8, 10-11) can be made of ceramics (majolica, faience, porcelain), glass, crystal, plastic, polymeric or composite materials, metal alloys, stainless steel, bronze, silver, and gold. A combination of the materials is also possible, for example, the main container made of glass or ceramic, the additional storage—metal or plastic.

When the beverage mug is used (FIGS. 1, 2), the liquid overflowing the rim of the main container 1 begins to flow down the rear falls to the chute 2 directing it, through the drain holes 3, to the additional storage 4. Since during drinking the tilt axis of the beverage mug (if held in the usual way by the handle) is parallel to the axis of the drain holes, the liquid stays in the storage 4 chamber (not flowing out no matter how the beverage mug is tilted). The embodiment with the two drain holes is the most efficient, because the higher slope makes the liquid flow faster. Besides, it is easier to wash the storage chamber with two drain holes.

While this invention has been particularly shown and described with references to preferred embodiments thereof, it will be understood by those skilled in the art that various changes in form and details may be made therein without departing from the scope of the invention encompassed by the appended claims.

What is claimed is:

1. A beverage mug comprising
a main wall having an internal surface and an external surface, and an additional wall having an internal surface of the additional wall;
a main container for a liquid formed by the internal surface of the main wall of the mug and a bottom of the main container integrally formed with the main wall,
a storage chamber for collection of a spillage flowing down the external surface of the main wall of the mug, the storage chamber located below the main container and formed by the internal surface of the additional wall and a bottom of the storage chamber,
a chute for directing the spillage flowing down the external surface of the mug to the storage chamber, the chute having at least one lower point connected to at least one hole in the additional wall of the storage chamber; and
a handle having a first end attached to the main wall of the mug, and a second end attached to either the main wall or the additional wall of the mug.

2. The beverage mug of claim 1, wherein the additional wall of the mug is a continuation of the main wall.

3. The beverage mug of claims 1, wherein the chute has two lower points connected to holes of the storage chamber.

4. The beverage mug of claim 1, wherein the storage chamber has two holes in its wall, one of the two holes is located below or above a lower end of the handle, and the other of the two holes is located diametrically opposite.

5. The beverage mug of claim 1, wherein the chute has a shape of a closed curve and has slopes formed between its upper and lower points.

6. The beverage mug of claim 4, wherein the chute comprises two separate parts having ends, and wherein the ends of the two separate parts are connected to the holes of the storage chamber.

7. The beverage mug of claim 1, wherein the chute comprises at least two segments disposed in a descending order.

8. The beverage mug of claim 1, wherein the additional wall is integrally formed with the bottom of the storage chamber and is detachably mounted on the main wall of the mug.

9. The beverage mug of claim 1, wherein all parts of the mug are integrally formed.

10. The beverage mug of claim 1, wherein the bottom of the storage chamber is a replaceable element comprising an absorbent material deposited on a base.

11. The beverage mug of claim 1, wherein the bottom of the main container is spherical.

12. The beverage mug of claim 2, wherein the storage chamber has two holes in its wall, one of the two holes is located below or above a lower end of the handle, and the other of the two holes is located diametrically opposite.

13. The beverage mug of claim 3, wherein the storage chamber has two holes in its wall, one of the two holes is located below or above a lower end of the handle, and the other of the two holes is located diametrically opposite.

14. The beverage mug of claim 7, wherein the additional wall is integrally formed with the bottom of the storage chamber and is detachably mounted on the main wall of the mug.

15. The beverage mug of claim 6, wherein the additional wall is integrally formed with the bottom of the storage chamber and is detachably mounted on the main wall of the mug.

16. The beverage mug of claim 5, wherein the additional wall is integrally formed with the bottom of the storage chamber and is detachably mounted on the main wall of the mug.

17. The beverage mug of claim 4, wherein the additional wall is integrally formed with the bottom of the storage chamber and is detachably mounted on the main wall of the mug.

18. The beverage mug of claim 8, wherein the bottom of the main container is spherical.

19. The beverage mug of claim 4, wherein the bottom of the main container is spherical.

20. The beverage mug of claim 10, wherein the bottom of the main container is spherical.
